(19) United States
(12) Patent Application Publication
(10) Pub. No.: US 2014/0096031 A1
(43) Pub. Date: Apr. 3, 2014

(54) IMAGE DISPLAY SYSTEM AND IMAGE DISPLAY DEVICE

(71) Applicant: GE MEDICAL SYSTEMS GLOBAL TECHNOLOGY COMPANY, LLC, Waukesha, WI (US)

(72) Inventor: Tatsuo Kawanaka, Tokyo (JP)

(73) Assignee: GE MEDICAL SYSTEMS GLOBAL TECHNOLOGY COMPANY, LLC, Waukesha, WI (US)

(21) Appl. No.: 14/038,147

(22) Filed: Sep. 26, 2013

(30) Foreign Application Priority Data
Sep. 28, 2012 (JP) 2012-215773

(51) Int. Cl. G06F 3/0484; H04L 29/06

(52) U.S. Cl. CPC G06F 3/04845; H04L 65/602
USPC 715/751

(57) ABSTRACT

An image display system is provided. The image display system includes a data server configured to store image data, a display terminal configured to display an image based on image data obtained from the data server and configured to receive additional information from an operator to be added to the image, and an information sharing unit configured to store specification information and the additional information, the specification information specifying additional image data added on the image with the additional information. The information sharing unit is configured to store additional information and specification information inputted at a plurality of display terminals, and, when the image data obtained from the data server coincides with the additional image data, the display terminal is configured to display the image and the additional information.

### CROSS REFERENCE TO RELATED APPLICATIONS

This application claims the benefit of Japanese Patent Application No. 2012-215773 filed Sep. 28, 2012, which is hereby incorporated by reference in its entirety.

### BACKGROUND OF THE INVENTION

The present invention relates to an image display system and an image display device which display an image based on image data stored in a server on a display terminal.

There have been image display systems in which an image based on image data stored in a server is displayed on a display terminal. For example, JP-A No. 2008-71163 discloses an image display system in which: image addresses are stored in a data index server; the location of image data is determined based on an image address stored in the data index server; and the image based on the image data is displayed on a display terminal.

There are cases in which, with additional information such as a flag added by an operator to an image displayed on a display terminal, it is desired, when the image is displayed on another display terminal, that the flag be also displayed along with the image. Namely, an image display system and an image display device are in demand which allow a flag added to an image to be shared between different display terminals.

### BRIEF DESCRIPTION OF THE INVENTION

In one aspect, an image display system is provided. The image display system includes a data server storing image data, a display terminal on which an image based on image data obtained from the data server is displayed and at which an operator adds additional information to the image, and an information sharing unit which stores specification information and the additional information, the specification information being for specifying image data on the image added with the additional information. The information sharing unit can store additional information and specification information inputted at a plurality of the display terminals, and, when image data obtained from the data server coincides with image data specified by the specification information stored in the information sharing unit, the image based on the image data is displayed along with the additional information on the display terminal.

In another aspect, an image display device displays an image based on image data obtained from a data server storing image data and allows an operator to add additional information to the image. The image display device displays, when the image data specified by specification information included in the information stored in an information sharing unit coincides with the image data obtained from the data server, the image based on the image data along with the additional information. The information sharing unit stores specification information specifying the image data on an image added with additional information and the additional information and is capable of storing the additional information and the specification information added to images at a plurality of the image display terminals.

According to the above aspects, an information sharing unit is provided which stores specification information for specifying image data on an image added with additional information inputted at the display terminal or the image display device and the additional information. At the display terminal or the image display device, the image specified by the specification information stored in the information sharing unit is displayed along with the additional information added to the image. Thus, additional information added to an image at a display terminal or an image display device can be displayed on another display terminal or another image display device.

### BRIEF DESCRIPTION OF THE DRAWINGS

FIG. 1 is a block diagram showing a configuration of an image display system according to a first embodiment.

FIG. 2 is a flowchart of operation of the image display system according to the first embodiment.

FIG. 3 shows display of an image collection on a display terminal.

FIG. 4 illustrates addition of a flag to an image by drag-and-drop of a flag icon.

FIG. 5 shows an image added with a flag.

FIG. 6 is a block diagram showing a configuration of a modification of the image display system according to the first embodiment.

FIG. 7 is a flowchart of operation of the modification of the image display system according to the first embodiment.

FIG. 8 shows the modification of the image display system according to the first embodiment in a state in which a portable storage medium disconnected from a display terminal where a flag was added to an image has been connected to another display terminal.

FIG. 9 is a block diagram showing a configuration of an image display system according to a second embodiment.

FIG. 10 is a block diagram showing a configuration of a modification of the image display system according to the second embodiment.

FIG. 11 is a block diagram showing a configuration of an image display system according to a third embodiment.

FIG. 12 is a flowchart of operation of the image display system according to the third embodiment.

FIG. 13 shows a web page image displayed on a display terminal.

FIG. 14 shows a web page image added with a flag displayed on a display terminal.

FIG. 15 is a block diagram showing a configuration of a modification of the image display system according to the third embodiment.

FIG. 16 is a flowchart of operation of the modification of the image display system according to the third embodiment.

FIG. 17 shows the modification of the image display system according to the third embodiment in a state in which a portable storage medium disconnected from a display terminal where a flag was added to an image has been connected to another display terminal.

FIG. 18 is a block diagram showing another example of configuration of the image display system according to the first embodiment.

### DETAILED DESCRIPTION OF THE INVENTION

Exemplary embodiments will be described herein.

### First Embodiment

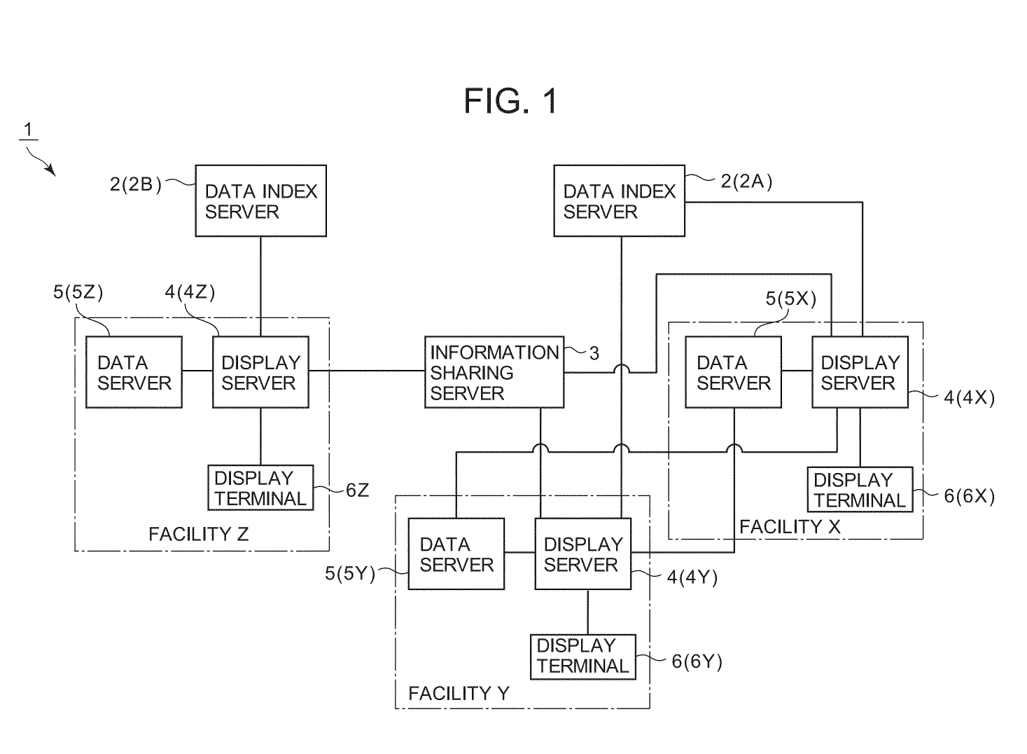

A first embodiment will be described based on FIGS. 1 to 5. An image display system 1 shown in FIG. 1 is for displaying an image at facilities X, Y, and Z, and includes data index servers 2 and an information sharing server 3. In FIG. 1, two data index servers 2 are shown (data index servers 2A and 2B).

The facilities X, Y, and Z are, for example, medical facilities such as hospitals and clinics. The facilities X, Y, and Z each have a display server 4, a data server 5, and a display terminal 6. To be specific, the facility X has a display server 4X, a data server 5X, and a display terminal 6X; the facility Y has a display server 4Y, a data server 5Y, and a display terminal 6Y; and the facility Z has a display server 4Z, a data server 5Z, and a display terminal 6Z.

In each of the facilities X, Y, and Z, the display server 4, the data server 5, and the display terminal 6 are interconnected by a LAN (Local Area Network). The display servers 4X and 4Y are connected to the data index server 2A and the information sharing server 3, for example, by a VPN (Virtual Private Network) or an exclusive line network. The display server 4X is connected to the data server 5Y by a VPN or an exclusive line network. The display server 4Y is connected to the data server 5X by a VPN or an exclusive line network.

The display server 4Z is connected the data index server 2B and the information sharing server 3 by a VPN or an exclusive line network.

The data index servers 2A and 2B, the information sharing server 3, the display servers 4, and the data servers 5 each have a well-known server configuration, so that their detailed configurations will not be described herein. When the image display system 1 is, for example, one which performs XDS (Cross-Enterprise Document Sharing), the data index servers 2A and 2B are registry servers and the display servers 4 are consumer servers. Also, the data servers 5 are, for example, repository servers.

The data servers 5 store image data. They each represent an exemplary embodiment of the data server. The image data is, for example, image data for medical. The image data for medical is data associated with patients generated, for example, at medical facilities or testing facilities where patients' specimens are tested and includes medical image data, document data and numerical data. The medical image data is, for example, X-ray computed tomographic images, MRI images (images obtained by magnetic resonance imaging), and ultrasound images collected using modalities at medical departments of the facilities X, Y, and Z. The document data includes, for example, radiogram interpretation reports, medical record lists, letters of consent such as surgical consent and medical test consent, medical questionnaires, written applications, and test results. PDF (Portable Document Format) data generated by scanning paper documents is also included in the document data. The numerical data is numerical data on patients, for example, blood test results.

Besides the above-mentioned medical image data and the document data, records of patients' biological information such as electrocardiogram records and other records on patients are also included in the medical data.

Metadata for the image data is stored in the data index servers 2A and 2B. The data index servers 2A and 2B each represent an exemplary embodiment of the data index server. When the image data is image data for medical, the metadata may include accompanying information of plural attributes, for example, patient name, patient ID, date, document type, document classification, department in charge, unique ID, and server ID of the relevant data server 5.

The “accompanying information” mentioned above refers to concrete relevant information such as patient name, patient ID, date, document type, document classification, and department in charge, whereas the “attributes” represent attributes of the accompanying information. For example, the accompanying information whose attribute is “document type” may be, for example, “CT” or “MRI” and the accompanying information whose attribute is “department in charge” may be, for example, “radiology department” or “cardiovascular department.” The metadata represents a concept combining attribute information (e.g. “document type” information) and concrete information about the attribute (i.e. accompanying information, e.g. “CT”).

The date included in the metadata is, for example, the date when the data for medical was generated and may include, in addition to a date, year and time. In the case of medical image data, the date may be the date when the image was obtained or, in the case of document data, the date may be the date when the document was generated or the date when the document was scanned for conversion into electronic data.

The document type included in the metadata is information to indicate a type of image data for medical. For example, it indicates a medical image type such as MRI or US (ultrasound) or a document type such as a hospitalization consent, an application for hospitalization, a questionnaire for hospitalization, a consent for medical test, or a consent for operation. The document classification included in the metadata represents a concept, for example, letter of consent, above the document type.

The department in charge included in the metadata is information to indicate a department which was in charge of generating medical data, for example, a radiology department or a cardiovascular department.

The unique ID (hereinafter referred to as “UID”) included in the metadata is information for identifying image data. The UID is an exemplary embodiment of the identification information. The server ID of a data server 5 included in the metadata is information for identifying the data server 5.

The data index server 2A stores metadata for the image data stored in the data servers 5X and 5Y. Namely, the data index server 2A is a server for managing the metadata for the image data stored in the data servers 5X and 5Y.

The data index server 2B stores metadata for the image data stored in the data server 5Z. Namely, the data index server 2B is a server for managing the metadata for the image data stored in the data server 5Z.

The display servers 4 store correspondence information ci to indicate correspondence between the URLs (Uniform Resource Locators) of the data servers 5 and the IDs of the data servers 5. Each of the display servers 4 stores the URL of the data index server 2 that is accessed by the display server 4. In the first embodiment, the display servers 4X and 4Y have access rights for accessing the data index server 2A, and the display server 4Z has an access right for accessing the data index server 2B. Hence, the displayer servers 4X and 4Y each store the URL of the data index server 2A, and the displayer server 4Z stores the URL of the data index server 2B.

The information sharing server 3 stores the UIDs of image data on images each attached with a flag, being described later, along with flag information which indicates that the images are each attached with a flag. The functions of the display servers 4 and the information sharing server 3 will be described later. The display servers 4 are each an exemplary embodiment of the display server. The information sharing server 3 is an exemplary embodiment of the information sharing unit and the information sharing server. The UID is an exemplary embodiment of the specification information for specifying image data. The flag and the flag information are exemplary embodiments of the additional information.

The information sharing server 3 can be accessed only by the display servers 4 having an access right. The display servers 4X, 4Y, and 4Z shown in FIG. 1 each have an access right for accessing the information sharing server 3. As being described later, when a flag is attached to an image at the display terminal 6X, 6Y, or 6Z, the corresponding display server 4X, 4Y, or 4Z performs operation to store the UID of the image data representing the flagged image in the information sharing server 3 along with the flag information. Namely, the information sharing server 3 can store the flag information generated at the display terminals 6X, 6Y, and 6Z.

The display terminals 6 are general-purpose personal computers and have a well-known computer configuration. The display terminals 6 are each an exemplary embodiment of the display terminal and the image display device.

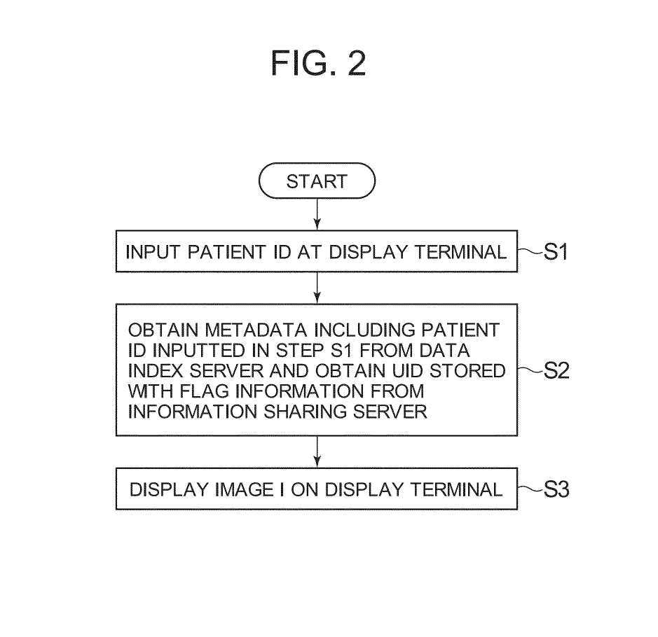

The operation of the image display system 1 of the first embodiment will be described below. First, the operation performed to display an image on one of the display terminals 6 will be described based on the flowchart of FIG. 2. In the following example case, the image to be displayed is one based on image data for medical. The image based on image data for medical may be, for example, a medical image based on the medical image data, a document image based on the document data, or a numerical image based on the numerical data.

Referring to FIG. 2, in step S1, an operator at one of the display terminals 6 inputs the patient ID of patient P an image of whom is to be displayed. Next, in step S2, the display terminal 6 outputs the patient ID to the corresponding display server 4 thereby making a request for image acquisition. Responding to the image acquisition request from the display terminal 6, the display server 4 obtains all metadata including the patient ID of patient P from the corresponding data index server 2. At this time, the particular index server 2 from which the metadata has been obtained is known to the display server 4.

Also, as being described later, the display server 4 obtains the flag information and UIDs from the information sharing server 3. The information obtained from the information sharing server 3 is about all patients including patient P and all other patients.

In the above step S2, the display server 4 obtains the metadata by accessing the data index server 2 memorized as an access destination. There are cases in which, in the foregoing step S2, the display server 4 obtains, in addition to the UIDs of the metadata stored in the data index server 2 accessible by the display server 4, the UIDs of the metadata stored in the other data index server 2 for which the display server 4 has no access right from the information sharing server 3.

Next, in step S3, the display server 4 has an image I based on the image data for medical on patient P displayed on the display terminal 6. Specifically, the display server 4 determines, based on the correspondence information ci, the URL of the data server 5 corresponding to the server ID included in the metadata obtained in step S2. The display server 4 then determines the location where the target image data is stored based on the URL of the data server 5 and the UID and obtains the image data from the data server 5.

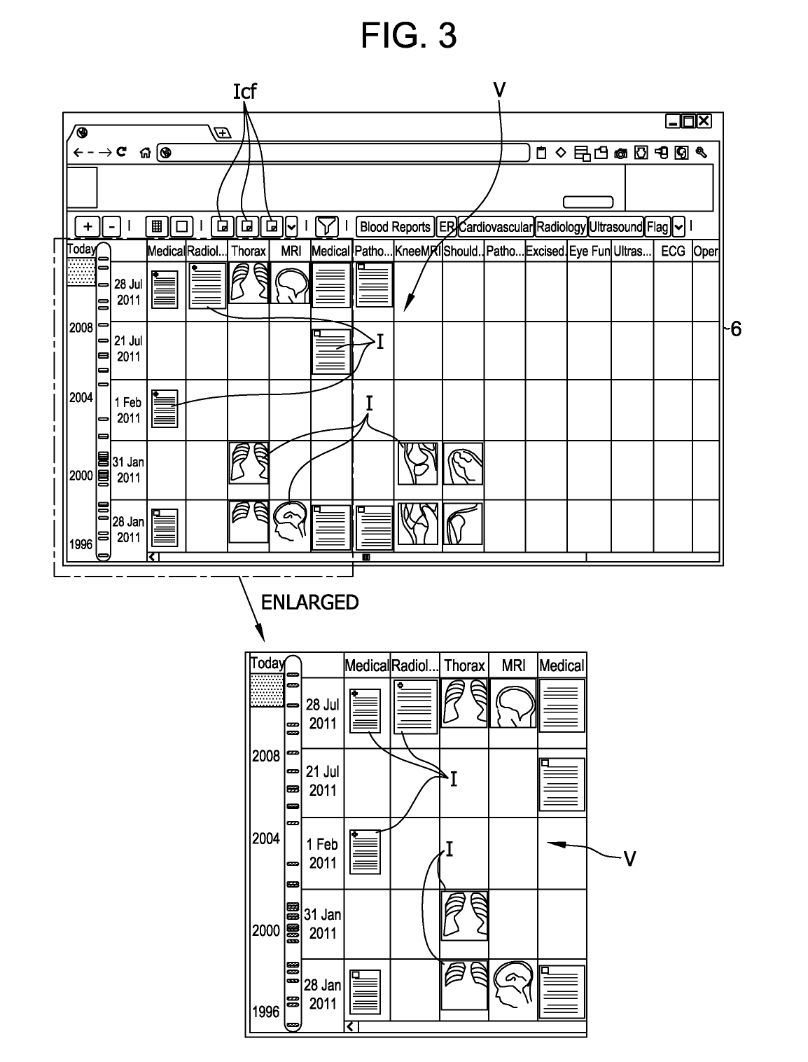

The display server 4 has the image I displayed, as shown in FIG. 3, on the display terminal 6 based on the image data obtained from the data server 5. In the present case, an image I collection V is displayed as the image I.

The collection V is an image showing a collection of thumbnail images I arranged, in a matrix format, by date and document type. In the present example, thumbnail images I of each document type are shown along a column and thumbnail images I of each date are shown along a row. The display server generates such thumbnail images by reducing the size of image data stored in the data server 5 into an appropriate number of pixels.

In cases where the image data for medical to be displayed as images I is numerical data, the display server 4 generates numerical data images and has them displayed as images I. A numerical data image is an image showing numeric data in characters. For example, numerical data representing blood test results is displayed as image I showing characters “BLOOD TEST.”

An arrangement may be made such that, by clicking the images I included in the collection V at an input unit (not shown) of the display terminal where the collection V is displayed, the operator can enlarge the display on the display screen.

The operator can add a flag to any image I included in the collection V displayed on the display terminal 6. The flag is for providing information about the flagged image I. Plural types of flags may be used to provide plural types of information.

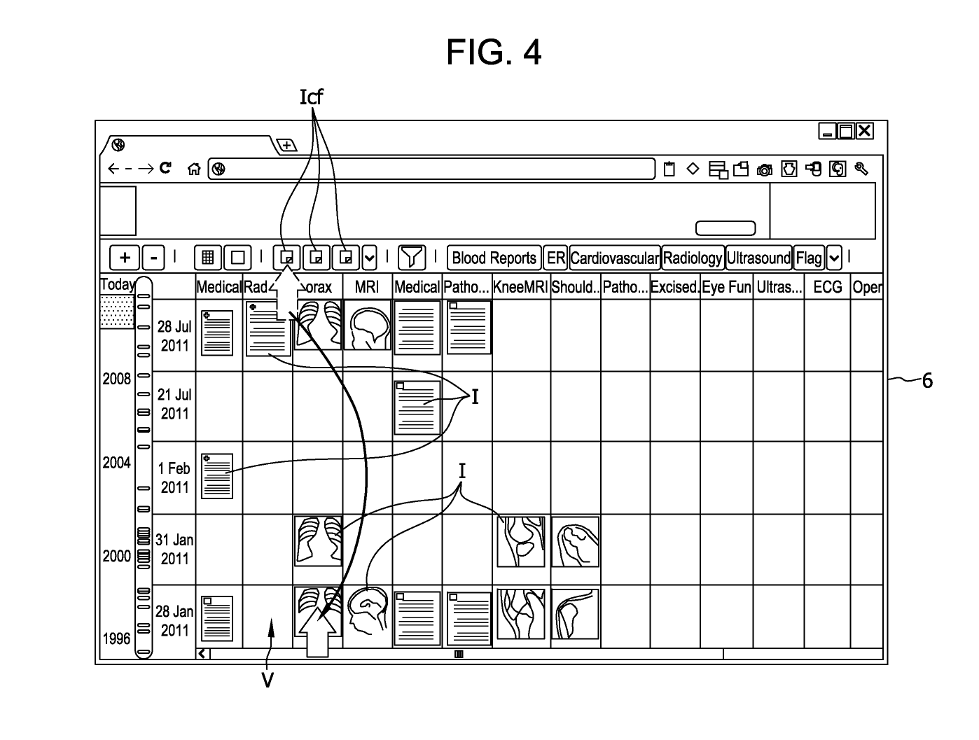

The flag setting operation will be described in detail below. First, as shown in FIG. 4, drag and drop a flag icon Icf onto an image I to be flagged. In the example shown in FIG. 4, there are three flag icons Icf which can be selectively used to set three types of flags. The three flag icons Icf are represented in three colors.

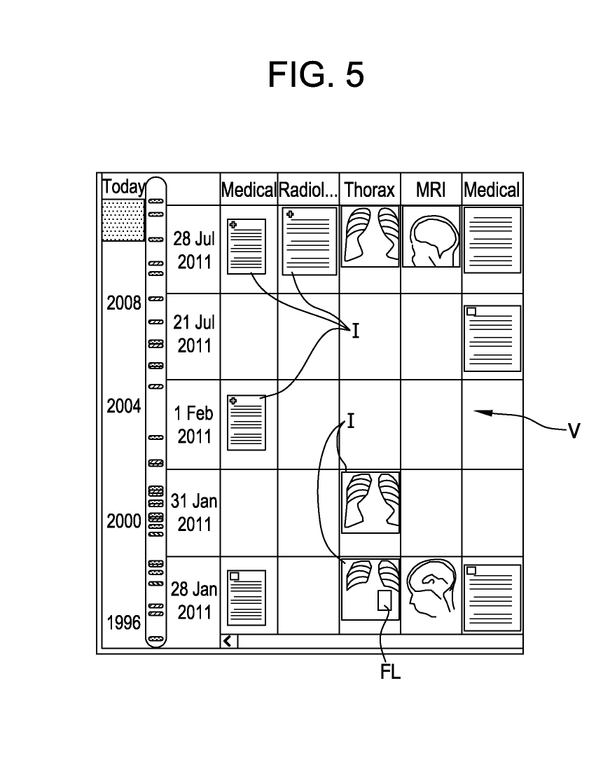

When one of the flag icons Icf is dragged and dropped onto an image I, a flag FL is added to the image I as shown in FIG. 5.

When the flag FL is added to the image I, the display server 4 transmits the UID of the image data on the flagged image I along with flag FL information to the information sharing server 3. The flag FL information includes information for identifying the type of the flag FL. The information sharing server 3 stores the UID and the flag FL information received from the display server 4. In the above step S2, the UID and the flag FL information thus stored in the information sharing server 3 are obtained by the display server 4.

In the above step S3, only when the image data obtained from the data server 5 coincides with the image data specified by the UID obtained from the information sharing server 3 in the above step S2, the display server 4 has the flag displayed on the image that is displayed, based on the image data, on the display terminal 6. Namely, in the above step S3, the display server 4 first determines the image data on the image I added with a flag FL based on the UID obtained, in the above step S2, from the information sharing server 3, then displays a flag FL on the image I that is displayed based on the image data thus determined.

According to the present example, the flag FL can be shared between the display terminals 6 connected to the display servers 4 that can access the same information sharing server 3. This will be described in further detail below. Assume, for example, that the image data on an image I of patient P is stored in the data servers 5X, 5Y, and 5Z. When, in this case, a flag FL is added to the image I at the facility Z, the UID of the image I added with the flag FL is stored in the information sharing server 3 along with the flag information. In this state, it is possible, not only when the image I of patient P is to be displayed on the display terminal 6Z at the facility Z but also when the image I of patient P is to be displayed on the display terminal 6X or 6Y at the facility X or Y, to determine the image data on the image I of patient P added with the flag FL based on the UID stored in the information sharing server 3 and has the flag FL displayed. Thus, according to the present example, a flag FL added to an image at the display terminal 6 connected to the display server 4 at one of the facilities X, Y, and Z can also be displayed on the display terminal 6 connected to either one of the other facilities. Namely, the flag FL can be shared between the display terminals 6 connected to the different display servers 4.

A different case in which, unlike in the present example, flag information is added to the metadata for the image data on a flagged image, then the metadata added with the flag information is stored will be described in the following. Assume that: an image I of patient P is stored at the facilities X, Y, and Z; the image I stored at the facility Z is added with a flag; metadata added with the flag information is stored in a server (not shown) which can be accessed only from the facility Z; and the display servers 4X and 4Y cannot access the server.

In this case, with the metadata added with the flag information stored in the server that can be accessed only by the display server 4Z, the flag cannot be displayed when the image I stored at the facility X or Y is displayed. In the present example, on the other hand, with the UID and the flag information stored in the information sharing server 3, any display server 4 which can access the information sharing server 3 can display the image I added with the flag on the display terminal 6.

According to the present example, the information sharing server 3 storing the UIDs stores no information to identify individuals, so that the security level of the information sharing server 3 need not necessarily be high.

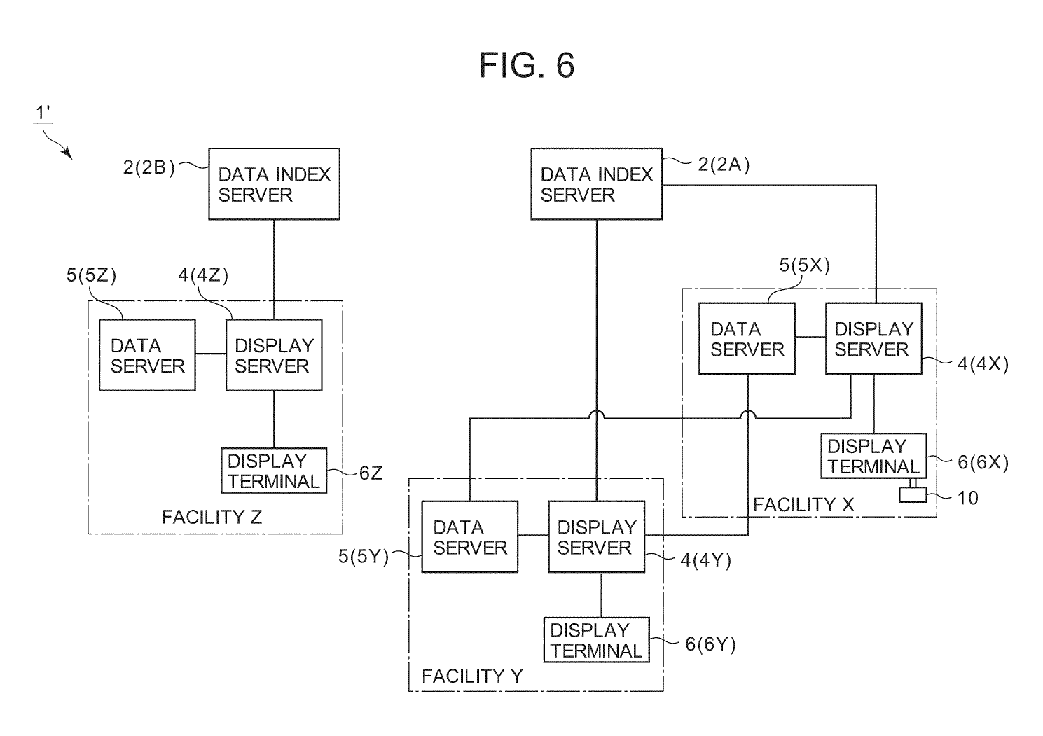

Next, a modification of the first embodiment will be described. As shown in FIG. 6, an image display system 1′ according to the modification does not include the information sharing server 3. In this case, the UID of the image data on an image added with a flag is stored in a portable storage medium 10 along with flag information. The portable storage medium 10 is, for example, a USB (Universal Serial Bus) memory and is connected to a display terminal 6.

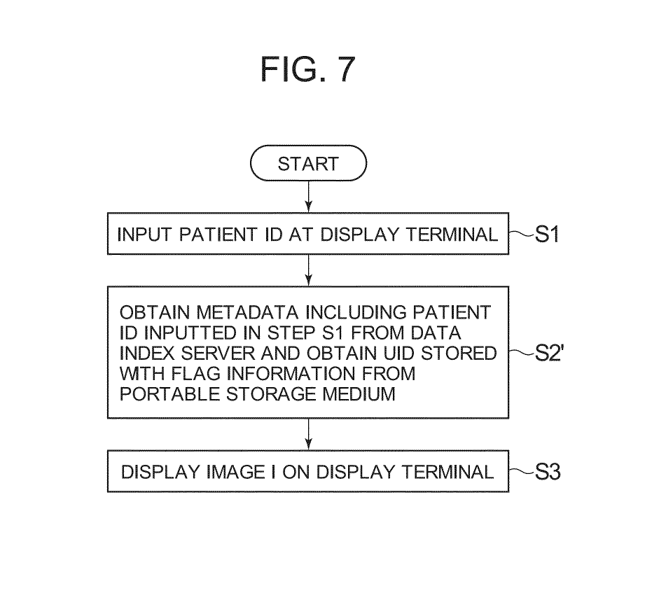

The operation performed in this case will be described below based on the flowchart shown in FIG. 7. The flowchart shown in FIG. 7 is basically the same as the flowchart shown in FIG. 2, but, in step S2′ of the flowchart shown in FIG. 7, the display server 4 obtains the UID and the accompanying flag information from the portable storage medium 10 connected to the display terminal 6. Subsequently, in step S3, the display server 4 determines the image data on the image added with a flag FL based on the UID obtained and has the flag FL displayed on the display terminal 6.

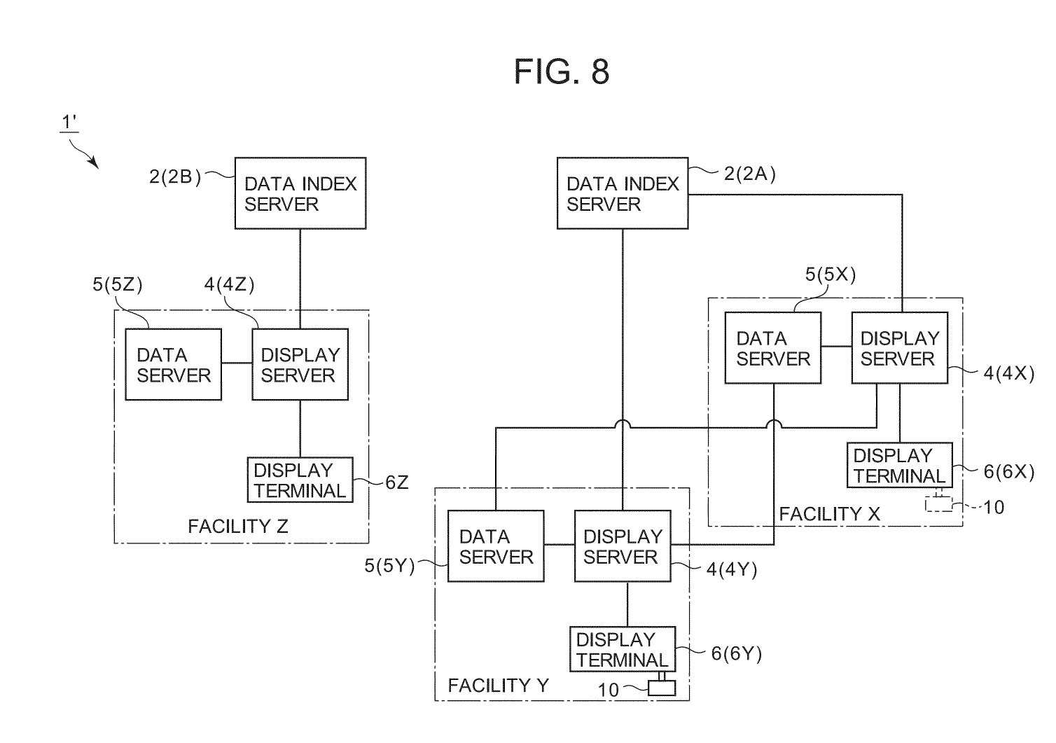

Referring to FIG. 6, the portable storage medium 10 is connected to the display terminal 6X at the facility X. Assume that, in this state, a flag FL is added to an image at the display terminal 6X and that the UID is stored in the portable storage medium 10 along with the flag information. This makes it possible to display the flag FL added to the image at the display terminal 6X on the display terminal 6Y by connecting the portable storage medium 10 to the display terminal 6Y at the facility Y as shown in FIG. 8. Specifically, in the above step S2′, the display server 4Y obtains the UID stored along with the flag information from the portable storage medium 10 connected to the display terminal 6Y. Based on the UID thus obtained, the display server 4Y determines the image data on the image added with the flag FL and has the flag FL displayed on the display terminal 6.

According to the present example, the flag FL added to an image at a first display terminal 6 can be displayed on a second display terminal 6 by connecting the portable storage medium 10 to the second display terminal 6. Thus, the flag FL can be shared between different display terminals 6.

### Second Embodiment

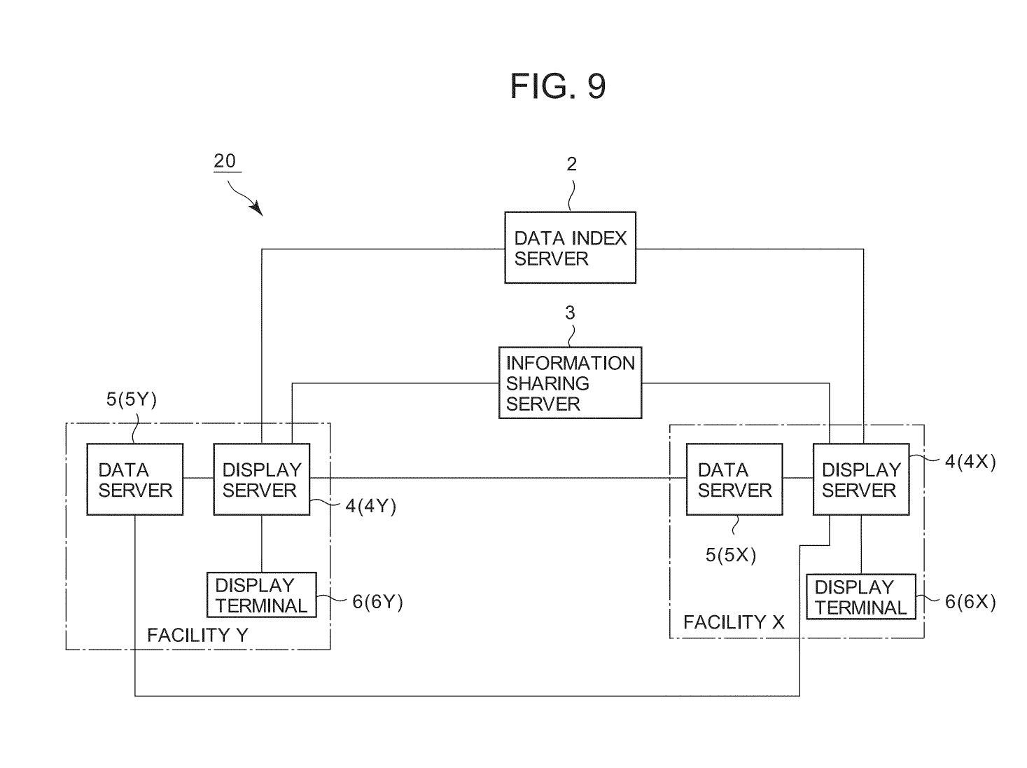

A second embodiment will be described below based on FIG. 9. Parts identical to those used in the first embodiment are denoted by the same reference numerals and symbols as used in connection with the first embodiment. An image display system 20 shown in FIG. 9 has only one data index server 2 and includes the facilities X and Y. The foregoing facility Z is not included in the image display system 20.

In the image display system 20, the image I can be displayed and the flag FL can be added to the image I in the same way as done in the first embodiment.

In the image display system 20 of the second embodiment, too, the flag FL can be shared between different display terminals 6 as in the first embodiment.

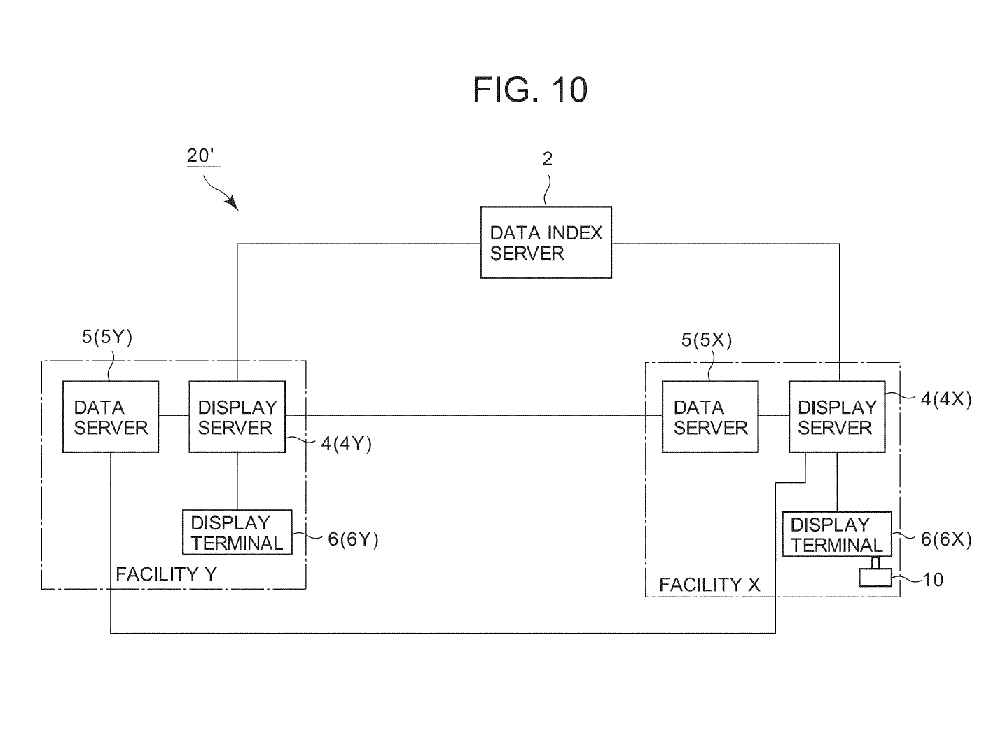

Next, a modification of the second embodiment will be described. As shown in FIG. 10, the modification of the second embodiment, like the modification of the first embodiment, includes no information sharing server 3, and the UID of the image data of an image added with a flag is stored in the portable storage medium 10 along with the flag information. Based on the UID stored in the portable storage medium 10, the display server 4 has the flag FL displayed.

### Third Embodiment

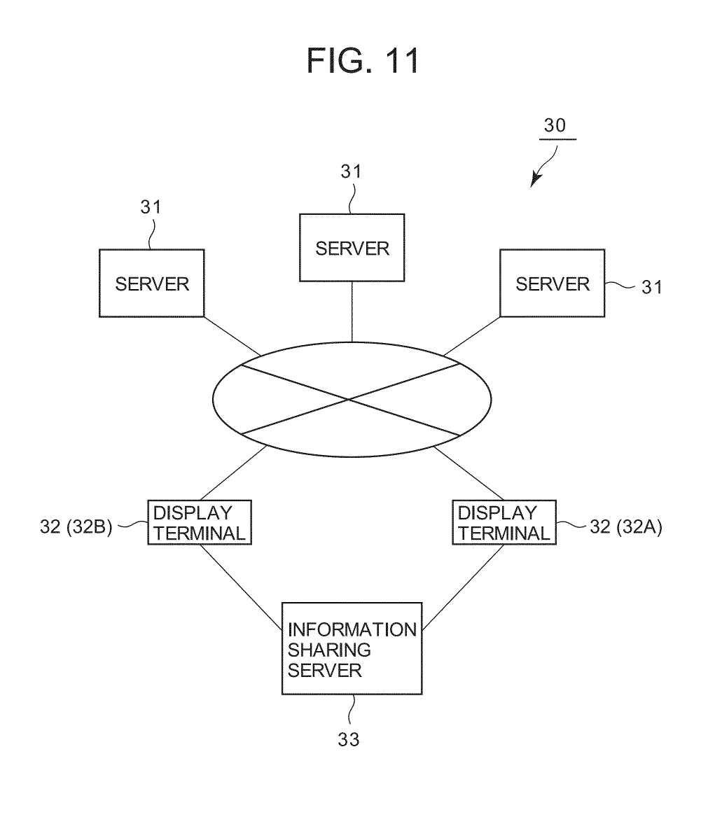

A third embodiment will be described below based on FIG. 11. An image display system 30 shown in FIG. 11 includes servers 31, display terminals 32, and an information sharing server 33.

Referring to FIG. 11, there are three servers 31 and two display terminals 32, i.e. 32A and 32B. The three servers 31 and the two display terminals 32A and 32B are interconnected by a network.

Each server 31 stores image data, for example, data on web-page images. Each server 31 is an exemplary embodiment of the data server.

The information sharing server 33 stores, as being described later, the URIs (Uniform Resource Identifiers) indicating the locations where image data on images each added with a flag along with flag information is stored. The same as in the foregoing embodiments, the flag information is for indicating addition of a flag. The URI is an exemplary embodiment of the specification information for specifying image data. The information sharing server 33 is an exemplary embodiment of the information sharing unit and the information sharing server.

The servers 31 and the information sharing server 33 each have a well-known server configuration, so that their detailed configurations will not be described herein.

The display terminals 32A and 32B are general-purpose personal computers each having a well-known computer configuration. The display terminals 32A and 32B are connected to the information sharing server 33 by a network and they each have an access right for accessing the information sharing server 33. As being described later, when a flag is added to an image at the display terminal 32A or 32B, the display terminal 32A or 32B performs operation to store the URI along with the flag information. Therefore, the information about flags added to images at the display terminal 32A or 32B can be stored in the information sharing server 33.

The display terminals 32A and 32B each have software installed therein for setting and displaying a flag. The display terminals 32 are each an exemplary embodiment of the display terminal and the image display device.

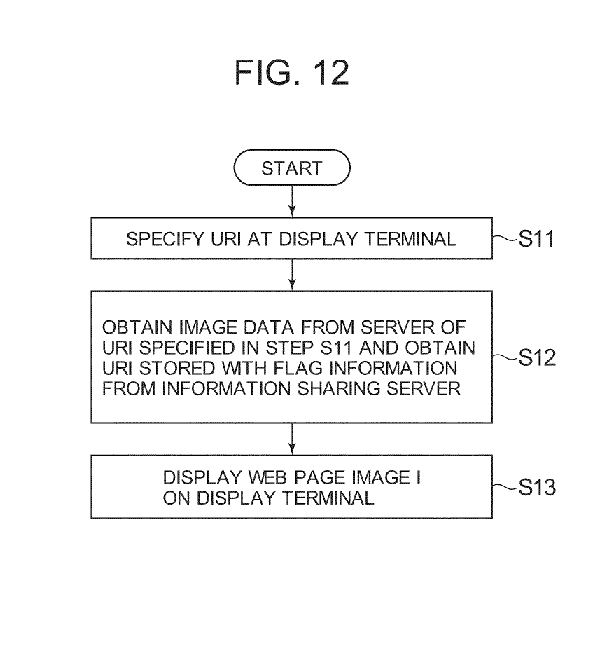

The operation of the image display system 30 of the third embodiment will be described below. First, the operation performed to display an image on a display terminal 32 will be described based on the flowchart shown in FIG. 12. Assume that the image to be displayed on the display terminal 32 is a web-page image.

First, in step S11, an operator at the display terminal 32 specifies a URI.

Next, in step S12, the display terminal 32 outputs an image acquisition request to the server 31 storing the specified URI and obtains the image data from the server 31. The display terminal 32 also obtains the URI stored, as being described later, along with flag information from the information sharing server 33.

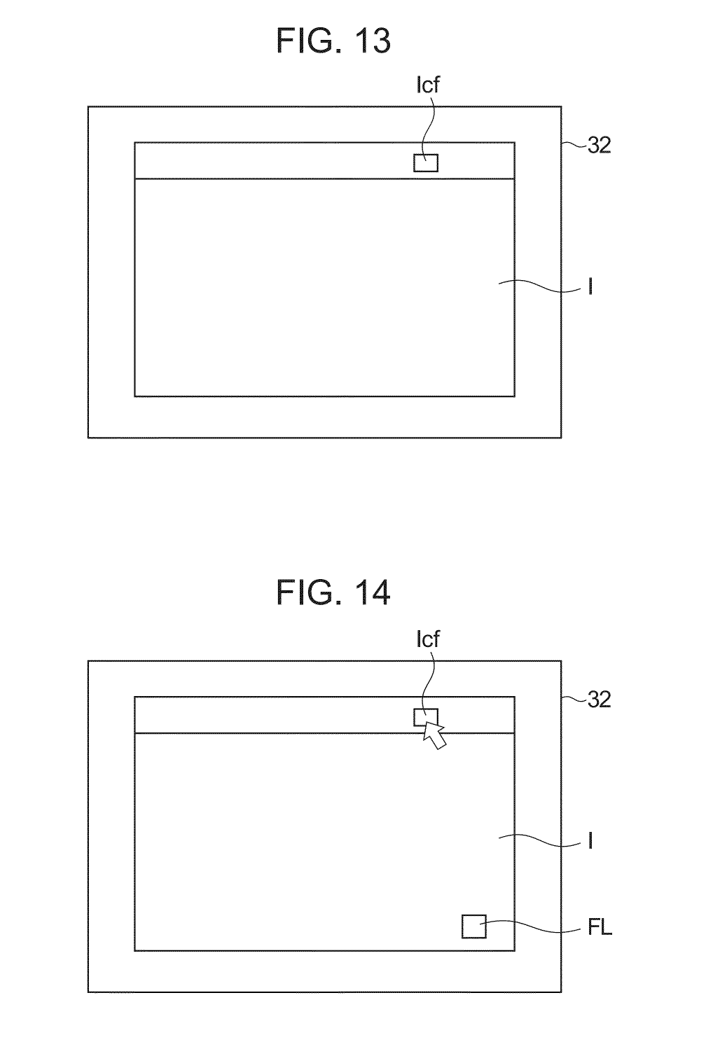

Next, in step S13, the web-page image I based on the image data obtained in step S12 is displayed on the display terminal 32 as shown in FIG. 13. The operator can add a flag to the image I displayed on the display terminal 32.

The operation to add a flag to an image will be described below. As shown in FIG. 13, a flag icon Icf is displayed on the display terminal 32. When the flag icon Icf is clicked, a flag FL is added to the image I as shown in FIG. 14.

When the flag FL is added to the image I, the display terminal 32 transmits the URI of the image data on the image I added with the flag FL to the information sharing server 33 along with the flag FL information. The URI transmitted from the terminal display 32 is stored in the information sharing server 33 along with the flag FL information. In this way, in step S12, the URI and the flag FL information stored in the information sharing server 33 is obtained by the display terminal 32.

In step S13, when the image data obtained from the server 31 coincides with the image data determined based on the URI obtained, in step S12, from the information sharing server 33, the display terminal 32 adds a flag to the image displayed, based on the image data, on the display terminal 6. Namely, when the URI obtained from the information sharing server 33 in step S12 and the URI specified in step S11 coincide, the display terminal 32 has, in step S13, a flag FL displayed on the image I.

In the present example, the flag FL can be also shared between plural display terminals 32 which can access the same information sharing server 33. For example, when a flag FL is added to an image I at the display terminal 32A, the URI of the image I added with the flag FL is stored in the information sharing server 33 along with the flag information. Subsequently, when the image I added with the flag FL is displayed on the display terminal 32B, the flag FL is shown on the image I.

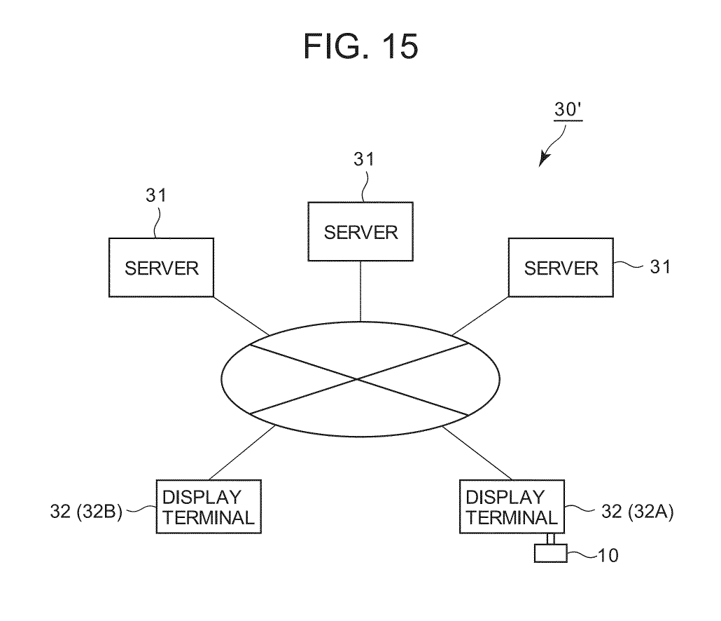

A modification of the third embodiment will be described below. As shown in FIG. 15, an image display system 30′ of the modification has no information sharing server 33. In this modification, as in the modifications of the first and the second embodiment, the URI of the image data on an image added with a flag is stored in the portable storage medium 10 along with the flag information. The portable storage medium 10 is connected to a display terminal 32.

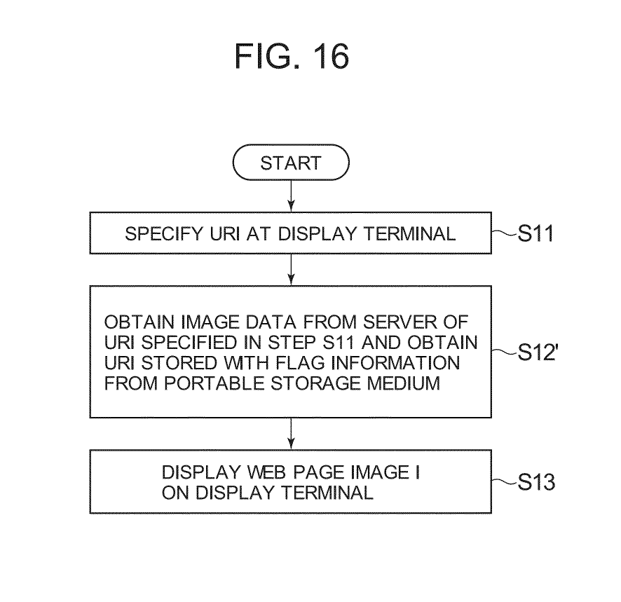

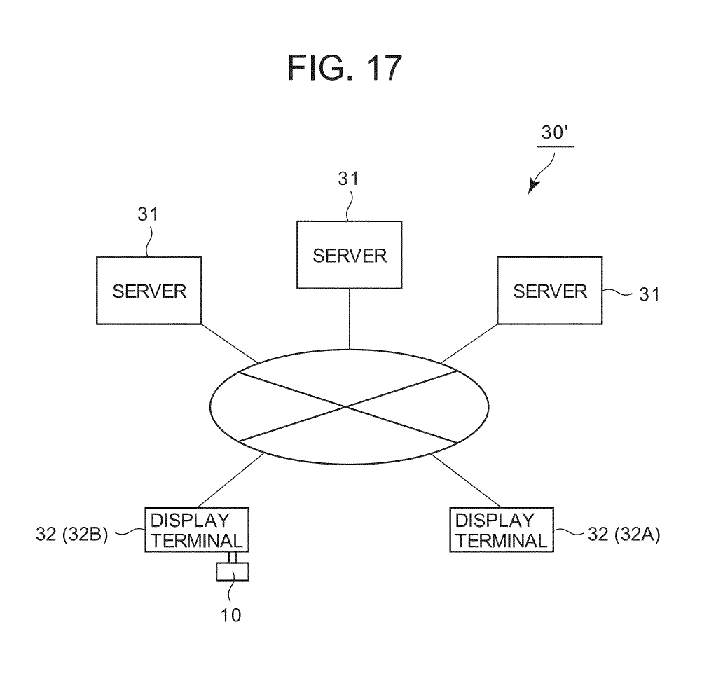

The operation performed in the modification of the third embodiment will be described based on the flowchart shown in FIG. 16. The flowchart shown in FIG. 16 is basically the same as the flowchart shown in FIG. 12, but, in step S12′, the display terminal 32 obtains the URI stored along with the flag information from the portable storage medium 10 connected to the display terminal 32. Subsequently, when the image data obtained from the server 31 coincides with the image data specified by the URI obtained from the portable storage medium 10, the display terminal 32 displays, in step S13, the flag FL.

Referring to FIG. 15, the portable storage medium 10 is connected to a display terminal 32A. Assume that, in this state, a flag FL is added to an image at the display terminal 32A and that the URI is stored in the portable storage medium 10 along with the flag information. This makes it possible to display the flag FL added to an image at the display terminal 32A on the display terminal 32B by connecting the portable storage medium 10 to the display terminal 32B as shown in FIG. 10. To be concrete, in the foregoing step S12′, the display terminal 32B obtains the URI stored along with the flag information from the portable storage medium 10. Subsequently, in step S13, when the image data obtained from the server 31 coincides with the image data specified by the URI obtained from the portable storage medium 10, the display terminal 32B displays the flag FL.

According to the present example, the flag FL added to an image at a first display terminal 32 can be displayed on a second display terminal 32 by connecting the portable storage medium 10 to the second display terminal 32. Thus, the flag FL can be shared between different display terminals 32.

The disclosure has been described based on the above embodiments, but the systems and methods described herein can be modified in various ways within the scope and spirit of the invention. For example, the additional information according to the present information is not limited to the flag FL and it may be, for example, a tag. Or, it may also be a note which is textual information inputted by an operator.

In the first and the second embodiment, the metadata may include a URI. When a URI is included, the information sharing server 3 or the portable storage medium 10 may store the URI instead of the UID.

In the first and the second embodiment, with each UID being unique, the information sharing server 3 may store UIDs only. However, in cases where there can be identical UIDs included in metadata stored in different data index servers 2, the URLs of the data index servers 2 are also stored, in addition to the UIDs, in the information sharing server 3 and the portable storage medium 10. In this case, the image data on an image added with a flag is determined based on the corresponding UID and the URL of the corresponding data index server 2. The UIDs and the URLs of the data index servers 2 are exemplary embodiments of the specification information.

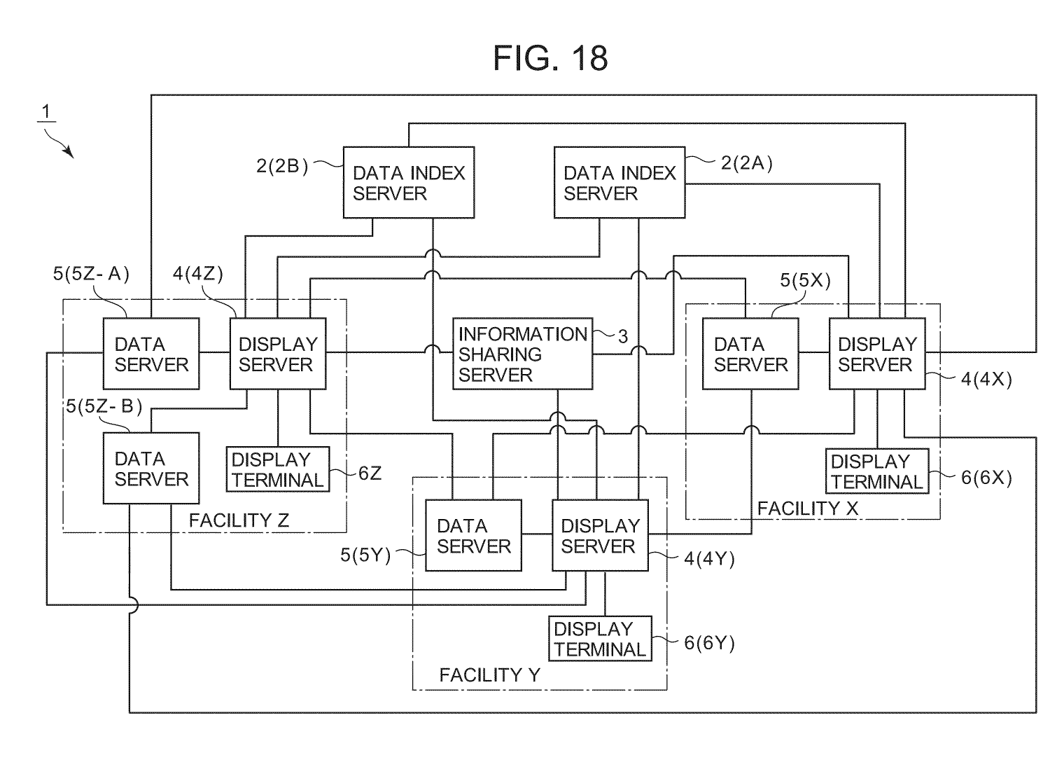

The image display system 1 may have a configuration as shown in FIG. 18. FIG. 18 differs from FIG. 1 in that the facility Z has data servers 5Z-A and 5Z-B. The display servers 4 of the facilities X, Y, and Z are connected to the data index servers 2A and 2B and the information sharing server 3, for example, by a VPN or an exclusive line network. The display servers 4 of the facilities X, Y, and Z obtain metadata by accessing the data index servers 2A and 2B.

The display server 4 of each facility is connected to the data servers of the other facilities, for example, by a VPN or an exclusive line network.

The data index server 2A stores the metadata for the image data stored in the data servers 5X, 5Y, and 5Z-A. Namely, the data index server 2A is for managing the metadata for the image data stored in the data servers 5X, 5Y, and 5Z-A.

The data index server 2B stores the metadata for the image data stored in the data server 5Z-B. Namely, the data index server 2B is for managing the metadata for the image data stored in the data server 5Z-B.

1. An image display system comprising:
a data server configured to store image data;
a display terminal configured to display an image based on image data obtained from the data server and configured to receive additional information from an operator to be added to the image; and
an information sharing unit configured to store specification information and the additional information, the specification information specifying additional image data added on the image with the additional information,
wherein the information sharing unit is configured to store additional information and specification information inputted at a plurality of display terminals, and
wherein, when the image data obtained from the data server coincides with the additional image data, the display terminal is configured to display the image and the additional information.

2. The image display system according to claim 1, wherein the information sharing unit is an information sharing server.

3. The image display system according to claim 1, wherein the information sharing unit is a portable storage medium.

4. The image display system according to claim 3, wherein the portable storage medium is connected to the display terminal.

5. The image display system according to claim 1, comprising:
at least one data index server configured to store metadata which includes identification information for identifying the image data stored in the data server; and
a display server configured to:
obtain, based on an image acquisition request from the display terminal, metadata for the corresponding image data from the at least one data index server;
determine a location where the corresponding image data is stored based on the identification information and information about the location of the data server;
obtain the image data from the data server; and
display the image based on the image data on the display terminal, wherein the display server is configured to obtain the specification information and the additional information from the information sharing unit and, when the image data obtained from the data server coincides with the additional image data specified by the specification information, cause the image and the additional information to be displayed on the display terminal.

6. The image display system according to claim 5, wherein, when the additional information is added to the image at the display terminal, the display server is configured to perform an operation to store the specification information and the additional information in the information sharing unit.

7. The image display system according to claim 5, wherein the identification information included in metadata is stored in the information sharing unit as the specification information.

8. The image display system according to claim 5, wherein the display server, while obtaining the metadata by accessing a first data index server for which the display server has an access right, is configured to obtain the additional information and specification information about the image data corresponding to the metadata from the information sharing unit, wherein the metadata is stored in the first data index server and in a second data index server for which the display server has no access right.

9. The image display system according to claim 5, wherein the display server has an access right for accessing the information sharing unit.

10. The image display system according to claim 5, comprising a plurality of data servers, display servers, and display terminals interconnected by a network.

11. The image display system according to claim 5, wherein the specification information comprises the identification information.

12. The image display system according to claim 5, wherein the specification information comprises the identification information and a data index server URL.

13. The image display system according to claim 1, wherein the display terminal is configured to:
issue an image acquisition request to the data server;
obtain image data from the data server;
display an image based on the image data;
obtain the specification information and the additional information from the information sharing unit; and
when the image data obtained from the data server coincides with the additional image data specified by the specification information, display the image based on the image data along with the additional information.

14. The image display system according to claim 13, wherein, when the additional information is added to the image, the display terminal is configured to perform an operation to store the additional information and the specification information in the information sharing unit.

15. The image display system according to claim 13, wherein the display terminal has an access right for the information sharing unit.

16. The image display system according to claim 1, wherein the specification information comprises a URI indicating a location where the image data is stored.

17. An image display device configured to:
display an image based on image data obtained from a data server storing image data; and
receive from an operator additional information to be added to the image,
wherein the image display device is configured to display, when additional image data specified by specification information included in information stored in an information sharing unit coincides with the image data obtained from the data server, the image based on the image data along with the additional information,
wherein the information sharing unit stores the additional information and the specification information specifying the additional image data added on the image with the additional information, and
wherein the information sharing unit is configured to store additional information and specification information added to images at a plurality of image display terminals.

18. The image display device according to claim 17, comprising an image display system, the image display system comprising:
the data server;
at least one data index server configured to store metadata which includes identification information for identifying the image data stored in the data server; and
a display server configured to:
obtain, based on an image acquisition request from the display terminal, metadata for the corresponding image data from the at least one data index server;
determine based on the identification information and information about the location of the data server, a location where the corresponding image data is stored;
obtain the image data from the data server; and
display the image based on the image data on the image display device, the display server configured to obtain the specification information and the additional information from the information sharing unit and, when the image data obtained from the data server coincides with the additional image data specified by the specification information, cause the image and the additional information to be displayed on the image display device.

19. A method for displaying an image comprising:
storing image data on a data server;
displaying, on a display terminal, the image based on image data obtained from the data server;
receiving, at the display terminal, additional information from an operator to be added to the image;
storing specification information and the additional information on an information sharing unit, wherein the specification information specifies additional image data to be added to the image with the additional information; and
displaying, when the image data obtained from the data server coincides with the additional image data specified by the specification information, the image and the additional information.

20. The method according to claim 19, wherein storing specification information and additional information on an information sharing unit comprises storing specification information and additional information on an information sharing server.
